(19) United States
(12) Patent Application Publication
(10) Pub. No.: US 2012/0171331 A1
(43) Pub. Date: Jul. 5, 2012

(54) GROUND BEEF OR PROCESSED MEATS WITH IMPROVED HEALTH AND RHEOLOGICAL CHARACTERISTICS

(76) Inventors: GARY ERVIN, Naples, FL (US); Erin Ervin, Naples, FL (US)

(21) Appl. No.: 13/343,463

(22) Filed: Jan. 4, 2012

Related U.S. Application Data
(60) Provisional application No. 61/429,509, filed on Jan. 4, 2011.

(51) Int. Cl. A23L 1/317; A23L 1/308; A23L 1/314

(52) U.S. Cl. 426/73; 426/602; 426/647; 426/646; 426/72; 426/74; 426/574; 426/417; 426/644; 426/538

(57) ABSTRACT

The present embodiments include a ground meat, processed meat, game meat, or sausage that has improved health and taste characteristics. The embodiments include the addition to the meat of a fat emulsion that includes a healthier group of edible oils component, fiber component, water component, and other components that can add additional dietary benefits.

This application claims priority to provisional patent application Ser. No. 61/429,509 filed Jan. 4, 2011, the disclosure of which is incorporated by reference herein in its entirety.

### BACKGROUND OF THE INVENTION

1. Field of the Invention

The embodiments relate generally to ground meat or processed meat or game meat having improved health characteristics, including, for example, lower fat content, lower saturated fat content, additional antioxidant content, dietary fiber content, and reduction of negative cholesterol. Supplements, nutraceuticals, or nutritive ingredients can also be added to the ground meat or processed meat or game meat through a fat emulsion component to target certain health issues such as calcium for healthy bones, cholesterol control or triglyceride control that supports prevention of cardiovascular disease, protein supplementation, vitamins and minerals that support health and other potential health issues.

2. Description of Related Art

Ground meat, processed meat and game meats are made with added fat content that comes from animal fats. Guidelines for the ground beef, hamburger, ground chuck and other types of ground beef require that no extenders or non-beef ingredients are part of the structure. Below are some of the requirements for different ground beef products.

Chopped Beef or Ground Beef shall consist of chopped fresh and/or frozen beef with or without seasoning and without the addition of beef fat as such, shall not contain more than 30 percent fat, and shall not contain added water, phosphates, binders, or extenders. When beef cheek meat (trimmed beef cheeks) is used in the preparation of chopped or ground beef, the amount of such cheek meat shall be limited to 25 percent; and if in excess of natural proportions, its presence shall be declared on the label, and otherwise contiguous to the name of the product.

Hamburger shall consist of chopped fresh and/or frozen beef with or without the addition of beef fat as such and/or seasoning, shall not contain more than 30 percent fat, and shall not contain added water, phosphates, binders, or extenders. Beef cheek meat (trimmed beef cheeks) may be used in the preparation of hamburger only in accordance with the conditions prescribed in paragraph (a) of this section.

Beef Patties shall consist of chopped fresh and/or frozen beef with or without the addition of beef fat as such and/or seasonings. Binders or extenders, Mechanically Separated (Species) used in accordance with 319.6, and/or partially defatted beef fatty tissue may be used without added water or with added water only in amounts such that the product characteristics are essentially that of a meat patty.

Fabricated beef steaks, veal steaks, beef and veal steaks, or veal and beef steaks, and similar products, such as those labeled Beef Steak, Chopped, Shaped, Frozen, Minute Steak, Formed, Wafer Sliced, Frozen, Veal Steaks, Beef Added, Chopped/Molded/Cubed/Frozen, Hydrolyzed Plant Protein, and Flavoring shall be prepared by comminuting and forming the product from fresh and/or frozen meat, with or without added fat, of the species indicated on the label. Such products shall not contain more than 30 percent fat and shall not contain added water or extenders. Transglutaminase enzyme at levels of up to 65 ppm may be used as a binder. Beef cheek meat (trimmed beef cheeks) may be used in the preparation of fabricated beef steaks only in accordance with the conditions prescribed in paragraph (a) of this section. More is available at http://cfr.vlex.com/vid/319-15-miscellaneous-beef-products-19611343#ixzz18sUq4GS3

The problem with these standardized guidelines is that consumers are eating ground beef products with total fat upwards of 30 grams, saturated fat upwards of 12 grams, and cholesterol upwards of 200 milligrams per 4 oz serving in the largest volume of ground beef sold in the US and globally. Sausages and certain processed meats like salami have even higher fat, saturated fat and high cholesterol per serving. Standardized ground beef and processed meat requirements create an entire category of products with some of the highest negative health ramifications in the US and global food system.

There are many examples of meat emulsions that try to replace or mimic the look of ground beef and taste. These technologies attempt to create substitutes for ground beef. U.S. Pat. No. 7,736,686 issued to Dingman, et al., Jun. 15, 2010 is a meat emulsion technology that creates a finish product that looks like ground beef. Dingman uses protein from poultry, beef, pork, and fish and creates a meat substitute by using protein, fat, and fibrous material to replicate the appearance of ground meat. This patent does not describe a ground meat or processed meat product, but rather is related to a ground meat replacement.

U.S. Pat. No. 6,187,367 issued to Cho, et al., Feb. 13, 2001 discloses a meat emulsion that has a denaturized protein component, a starch component, and a meat component from beef, chicken, or pork. Cho creates a meat emulsion that can be ground into a ground beef format or stuffed in a casing like sausage. Cho discloses an emulsion that attempts to mimic ground meat by creating an emulsion, and does not disclose replacing the fat content within meat or to create a meat replacement product.

Other technologies look to extend meat or lower the fat content within meat. U.S. Pat. No. 5,858,442 issued to Payne, et al., Jan. 12, 1999, discloses a meat extender capable of lowering fat within meat systems. Payne utilizes a protein crumble added to water and then chopped to replace fat within meat or to extend meat. Animal derived proteins, carbohydrates, and gums are also potentially used in the Payne disclosure. U.S. Pat. No. 6,607,777 issued to Walsh, et al., Aug. 19, 2003 is another example of a meat extender made from a textured whey protein that contains an edible polysaccharide. Walsh discloses the use of inulin and the other dietary fibers as part of its potential ingredient structure.

U.S. Patent Application Publication No. 2009/0117247 filed by Felker, Frederick C.; et al., published on May 7, 2009, discloses a gel like substance that mimics meat fat characteristics. The USDA asked for an invention that could address the major problem of lean ground meats in that the taste profile goes down because the products have less fat. Felker discloses a gel like substance that is created by cooking the components at high temperature under pressure and adding the fat or oil component under shear. The taste profile of Felker therefore is diminished because its gel does not have properties similar to ground meat or processed meat fat. In addition, Felker discloses a dietary fiber content of about 9% or less, which may not provide the improved dietary fiber characteristics desired in a meat processing aid that reduces the fat content of meat. The Felker disclosure also utilizes a complicated and costly manufacturing process that requires an expensive, high pressure cooking process and then adds the fat or oil under shear that is also expensive.

The ability to provide the consumer with better tasting, leaner ground meats, processed meats and game meats as well as lowering the cost for the meats would be desirable to permit a larger group of consumers to select low fat meat products having potentially desirable dietary benefits. The high cost of lean and extra lean meats as well as lack of taste makes consumers less likely to purchase the lean and extra lean meat products. It would be desirable to provide meat products that address both of these concerns by creating a cheaper and better tasting lean and extra lean group of meat products.

### SUMMARY OF INVENTION

It is, therefore, a feature of an embodiment to provide a good taste, texture, and mouth feel ground meat or processed meat or game meat without the necessity of utilizing high levels of animal fat that is high in total fat, saturated fat, and cholesterol. Another feature of the embodiments is to improve the organoleptic properties of lean ground meat and processed meats and to lower the cost of these meat products. As the fat content goes down in ground meat and processed meats, the taste profile of the meats lessen and the cost goes up at retail. The meats become chewier and less juicy because of the lack of fat in the meat. Consumer's should choose to eat the lean or extra lean ground meat or processed meat products, but because of taste and higher cost, they typically choose to eat the higher fat products.

In accordance with these and other features of embodiments, there is provided a ground meat product that comprises:
a. from about 30% to about 98% of ground meat having a total fat content of from about 2% to about 50% by weight; and
b. from about 2% to about 70% of a fat emulsion comprising (1) from about 1 to about 30% of a highly unsaturated liquid edible oil, (2) from about 0.3 to about 10% of a highly saturated oil (e.g., coconut oil), (3) from about 0.001 to about 70% of a fiber component, (4) from about 0.001 to about 30% of a thickening component, and (5) the balance water.

In accordance with another feature of an embodiment, there is provided a method of making a meat composition that includes:
adding water to a mixing and heating vessel;
slowly adding a fiber component and a thickening component to the water while mixing to provide a homogeneous mixture;
adding a highly unsaturated liquid edible oil and a highly saturated oil while mixing to provide a homogeneous mixture;
heating the homogeneous mixture to a temperature within the range of from about 130 to about 175° F. while mixing for about 1 minute to about 90 minutes to emulsify the oil in water composition and create a fat emulsion;
reducing the temperature of the fat emulsion while mixing; and
adding meat at a temperature of from about 85 to about 125° F. to blend the emulsion into the meat and prepare a meat composition.

In accordance with another feature of an embodiment, there is provided a ground sausage made out of beef, pork, chicken, turkey or other meat or game meat that has improved taste, texture, and mouth feel when compared to regular ground sausage and has lower total fat, lower saturated fat, lower cholesterol, and beneficial dietary fiber and essential fatty acids Omega 6 and Omega 3 ALA's. In accordance with this embodiment, the ground sausage comprises:
a. from about 30% to about 98% of ground sausage selected from beef, turkey, chicken, pork, and mixtures thereof; and
b. from about 2% to about 70% of a fat emulsion comprising (1) from about 1 to about 30% of a highly unsaturated liquid edible oil, (2) from about 0.3 to about 10% of a highly saturated oil (e.g., coconut oil), (3) from about 0.001 to about 70% of a fiber component, (4) from about 0.001 to about 30% of a thickening component, and (5) the balance water.

In accordance with another feature of an embodiment, there is provided a method of making a sausage composition that includes:
adding water to a mixing and heating vessel;
slowly adding a fiber component and a thickening component to the water while mixing to provide a homogeneous mixture;
adding a highly unsaturated liquid edible oil and a highly saturated oil while mixing to provide a homogeneous mixture;
heating the homogeneous mixture to a temperature within the range of from about 130 to about 175° F. while mixing for about 1 minute to about 90 minutes to emulsify the oil in water composition and create a fat emulsion;
reducing the temperature of the fat emulsion while mixing; and
adding sausage at a temperature of from about 85 to about 125° F. to blend the emulsion into the sausage and prepare a sausage composition.

These and other features and advantages of the embodiments will become readily apparent from the detailed description that follows.

### DETAILED DESCRIPTION OF THE INVENTION

All percentages and ratios are calculated by weight unless otherwise indicated. All percentages and ratios are calculated based on the total final composition unless otherwise indicated. Referenced herein may be trade names for components including various ingredients utilized in the present invention. The inventors herein do not intend to be limited by materials under a given trade name. Equivalent materials (e.g., those obtained from a different source under a different name or reference number) to those referenced by trade name may be substituted and utilized in the description.

As used herein “fiber” generally denotes material derived from plant cell walls, including soluble fiber and insoluble fiber. The fiber component can be naturally derived or synthetic. A portion of the fiber component can be non-starch polysaccharides, including soluble and non soluble fiber. As used herein “soluble fiber” means plant gums and oligosaccharides, or modified gums, modified celluloses, non-starch polysaccharides that are soluble in water, some of which can form viscous gels.

As used herein, “ground meat” or “meat” may include meat and meat products, ground beef, ground meats, processed meats, game meats, sausage compositions and mixtures thereof. The meat products preferably are animal derived substances.

A feature of the embodiments is the creation of ground beef, chicken, turkey, pork and other processed meat or game meat products like sausage having added thereto a fat emulsion that creates meat products with substantially less total fat, saturated fat and cholesterol, while still maintaining improved rheological and taste characteristics. The embodiments can create ground beef and other ground meats, processed meats and game meats with extra lean FDA nutritional structures while contributing beneficial dietary fiber, substantially lower total fat, saturated fat, and cholesterol at the levels of 5 grams or less total fat, 2 grams saturated fat or less and 75 mg or less cholesterol per 100 gram serving size or smaller serving size, based on type of meat product. The taste profile of the meat compositions of the embodiments taste more like the full fat products because the fat emulsion added thereto allows the meat to maintain more of its moisture, and the fat emulsion has the same or similar rheological characteristics of meat fat, but has in some cases less than 5% fat content within its structure.

The health improvements of the American consumer and global consumer within certain embodiments are promising because the consumer enjoys ground beef and processed meats because of the taste, texture and satisfaction they get from the food product, while at the same time enjoy the benefits of reduce fats and cholesterol. A complete line of meat products prepared in accordance with the embodiments has the ability to lower cardiovascular disease and other conditions related to eating current meat products including obesity, high blood pressure and other health problems caused by high fat, saturated fat and cholesterol diets.

The ground beef industry consumption on a yearly basis is 8.4 billion pounds in the US alone. The majority of the ground beef consumed is 73/27 or 80/20 because of the taste and cost of the products vs. the leaner products like 90/10 or 95/5. The embodiments provide a fat emulsion that can be added to ground meat, processed meat or game meat that can produce lower cost-lean meat products with improved taste characteristics and health characteristics. The embodiments have the advantage of making a less expensive ground beef that tastes as good as the high fat ground beef products available to the consumer.

It is another feature of an embodiment to create a ground meat, processed meat, game meat, and/or sausage that can have an improved balance of dietary fats. These dietary fibers may include, for example, beneficial Omega 3 ALA's and Omega 6's by making use of oils like canola oil that can be used in formulating the fat emulsion that is added to the meat or processed meat product. Certain embodiments can create single serving sizes of ground meat or processed meat or game meat with an excellent source of dietary fiber to 35% Daily Value Dietary Fiber per serving.

Non-limiting examples of fiber components useful in the embodiments include, but are not limited to naturally derived soluble fiber; naturally derived inulin; inulin extract; synthetic inulin; hydrolysis products of inulin commonly known as fructooligosaccharides, galacto-oligosaccharides, xylooligosaccharides, or oligo derivatives of starch; husks; brans; psyllium; polysaccharides; oligosaccharides; celluloses and derivatives thereof; starches, modified starches, and derivatives of starches; polycarbophil; lignin; arabinogalactans; chitosans; oat fiber; soluble corn fiber; non-digestible corn or wheat dextrin; locust bean gum and derivatives thereof; hydroxypropylmethyl cellulose (HPMC); pectin; and mixtures thereof.

The preferred fiber component for use in the preferred embodiments can be selected from inulin, wheat dextrin, or fructooligiosaccharides. Inulin, wheat dextrin, and fructooligiosaccharides act as a thickening agent and also improve the texture of the flavored chewy or gummy confection and add beneficial dietary fiber to the composition. Various load rates of dietary fiber can be incorporated in the composition to create improved texture and at certain load rates can provide dietary benefits including promoting a healthy digestion system, controlling blood sugar levels, and providing probiotic benefits. The addition of the dietary fiber along with the remaining components allow for the addition of water that helps displace sugar within the flavored chewy or gummy confection.

Inulin is indigestible by human enzymes ptyalin and amylase, which are designed to digest starch. As a result, inulin passes through much of the digestive system intact. Inulin is a highly effective prebiotic, stimulating the growth of beneficial probiotic bacteria in the gut. Inulin is used in low fat products because of its ability to provide a creamy smooth texture to products. Inulin is a dietary fiber and is believed to activate beneficial good bacteria in the digestive tract. The activation of these bacteria is thought to reduce the risk of bowel cancer. Inulin has a mildly sweet taste, but does not affect blood sugar levels and is recommended for diabetics. Inulin has been clinically proven to increase calcium absorption. The inherent calcium in dairy foods is now an even better source of this bone-building mineral when inulin is added because inulin improves the body's uptake. People have used plants containing inulin to help relieve diabetes mellitus, a condition characterized by hyperglycemia and/or hyperinsulinemia. The embodiments can provide flavored chewy or gummy candy with inulin as the fiber component and calcium supplementation. This flavored chewy or gummy candy would have an improved absorption of calcium because of the inulin within its composition. Calcium is one of the top deficient minerals in the diet of most individuals, and products produced in accordance with the guidelines provided herein can provide great tasting flavored chewy or gummy confections that can help consumers get more calcium within their diets by eating our products.

The dietary fiber component, preferably Inulin, which also may help to create the texture and mouth feel of a true fat as well as provide positive health attributes. Dietary Fiber has been proven to help reduce the risk of colon cancer, improve digestion health, balance blood sugar, and has some probiotic benefits.

Soluble dietary fiber sources can also be used that allow for the FDA “Heart Healthy” soluble fiber claim to be made. These soluble fiber sources add beneficial dietary fiber that has proven health benefits including lowering cholesterol, promoting regularity, reducing the risk of colon cancer, balancing blood sugar and other health benefits.

It is another object of this invention to reduce the calorie content in meat products, which may be accomplished by utilizing the fat emulsion as a large percentage of the ground meat or processed meat so that when it replaces fat within the composition, the calorie content of the ground meat or processed meat will become lower. Water is a large percentage of the fat emulsion and has zero calories. Fat has around 8.5 calories per gram and the preferred fat emulsion described in the embodiments may have around 2.5 calories per gram. Accordingly, when the fat emulsion displaces fat in the ground beef, for example, the calorie reduction would be dramatic. In ground beef where large portion sizes are given like restaurant chains, the calorie reduction would be significant. A restaurant chain like McDonald's could completely change its hamburger nutritional structure utilizing the embodiments described herein. The hamburger would have less total fat, less saturated fat, less cholesterol, beneficial dietary fiber, fewer calories, and in certain embodiments of our invention the hamburger could be considered FDA “Heart Healthy”.

In one embodiment a ground meat or processed meat or game meat composition has similar or improved taste, texture, and mouth feel when compared to a higher fat content ground meat or processed meat, and has significantly improved taste, texture, and mouth feel when compared to lean or extra lean ground meat or processed meat. This ground meat or processed meat composition has beneficial essential fatty acids Omega 6 and Omega 3 ALA's, antioxidants, and dietary fiber.

Many patents have been granted for meat replacement systems or meat extenders. The embodiments focus on improving the health characteristics of ground meat, processed meat, game meat, and/or sausages by providing a fat emulsion composition that can be added to the meat that has the rheological characteristics of a fat. The fat emulsion composition based on certain embodiments can provide the rheological characteristics of meat fat like beef, pork, chicken, turkey or game meats in foods. The potential value for a fat emulsion composition that can replace these negative health characteristic fats or combination of fats while providing positive health benefits to the meat compositions can have a profound effect on consumer health globally. The competitive edge that a global marketer would have using the fat emulsion compositions of the embodiments combined with ground meat, processed meat, game meat, and/or sausages would be tremendous because the negative health ramifications from high fat content especially high saturated animal fat content found in current ground meat, processed meat or game meat can be significantly lowered to in some cases almost removed from the meat products.

The preferred embodiments can improve the health characteristics of ground meat, processed meat, game meat, and/or sausages while maintaining great taste, texture, and mouth feel of the product and do so with a dramatic reduction in fat, especially saturated fat. Over the last several years, Trans Fats have been removed from global food products and have been banned in New York City and in certain countries globally. Trans Fat produces a certain texture and mouth feel within foods and the global marketers removed the ingredient out primarily because of medical community pressure and consumer pressure on its negative health aspects. Within certain embodiments, a fat emulsion composition can produce similar texture and mouth feel within meat products that Trans Fat produces. This texture and mouth feel similar to Trans Fat within meat products can be created using a healthy fat emulsion composition that provides positive health benefits like; antioxidants, beneficial fatty acids Omega 3 ALA's and Omega 6, beneficial dietary fiber, lower fat content, saturated fat content and cholesterol. The nutritional content in meat products utilizing the fat emulsion composition of the embodiments allows many foods to be widely recommended by the medical community as healthy food choice.

The USDA and American Heart Association have been trying to persuade consumers to eat more lean cut and leaner types of ground meat, processed meats, and game meats. The above invention by Felker was funded by the federal government to find a way to improve the taste of lean and extra lean meats and to try to lower the cost of these products. The issue of taste and cost of lean or extra lean meats are problems that cause consumers to not choose these types of ground meat, processed meat or game meats.

First, as the fat content goes down in meat, the cost of the product goes up. The meat aspect of ground meat, processed meat or game meat is the highest cost portion of the product. So as the fat content goes up the cost of the product goes up. The below table shows how the cost goes up for the leaner types of ground beef and the issue of consumers having to pay more for healthier ground beef.

TABLE 1
Standard ground meat formulations and estimated cost per pound.

| Label | % Lean/% Fat | Cost per Pound* |
|---|---|---|
| Ground beef | 70/30 | $2.50 |
| Ground chuck | 85/15 | $2.78 |
| Ground round | 90/10 | $3.48 |
| Ground sirloin | 97/3 | $3.68 |

*Costs are estimates in 2003 and not exactly the current US prices, but within the range of the difference in cost per type of ground beef. The difference of $1.18 per pound makes many consumers choose the cheaper, higher fat content meats. The difference in cost of the above types of meats is even greater today and several grocery stores in 2010 have over a $1.50 difference in price per pound between the different types of ground beef.

Another problem with leaner meats is that as the fat content goes down, the ground beef or ground meat tends to get chewier and less moist when cooked. Extra Lean meat like the Ground sirloin above at 97/3 has only 3 percent fat content, but has poor rheological taste profile and most consumers do not prefer the taste of this ground beef.

The preferred embodiments described herein solve both of the major issues that lean ground meats, processed meats and game meats suffer from. The fat emulsion added to lean or extra lean ground meat, processed meats, game meats, or sausages, lowers the cost because the fat emulsion costs much less than the meat cost and when added at rates of 15% or high to lean or extra lean meats, the price of the product would be closer to the $2.50 price point for the ground beef 70/30. The fat emulsion also makes the lean or extra lean ground meat, processed meat, game meat, or sausage moister when cooked and less chewy. The embodiments improve both of the aspects that cause consumers to choose higher fat ground beef products and can have a profound effect improving consumer's health by giving them a better tasting, less expensive lean or extra lean ground meat, processed meat or game meat product.

A preferred embodiment is a ground meat composition comprising:
a. from about 30 to about 98% of ground meat having from about 2% to about 50% total fat; and
b. from about 2 to about 70% of a fat emulsion that includes the following:
   1. from about 1 to about 30% of a highly unsaturated liquid edible oil component;
   2 from about 0.3 to about 10% of a coconut oil component (medium heat refined coconut oil);
   3. from about 0.001 to about 70% of a fiber component (preferably Inulin);
   4. from about 0 to about 5% of a vanilla powder component on dextrose base;
   5 from about 0.001 to about 30% of a thickening component (Corn Starch);
   6. from about 0.001 to about 30% of an emulsifier component (Lecithin);
   7. from about 1 to about 60% of a water component; and
   8. from about 0 to about 1% of a natural preservative tocopherols.

A particularly preferred embodiment is a ground meat composition comprising: a. 85% an extra lean meat with 5% total fat or less and b. a 15% fat emulsion that includes one or more of the following:
I. highly unsaturated liquid edible oil component at 3.3%, by weight of said emulsion;
II. 8% coconut oil component (medium heat refined coconut oil);
III. a fiber component at 41% (Inulin), by weight of said composition;
IV. a vanilla powder component on dextrose base at 1.1%, by weight of said composition;
V. a thickening component at 15.6% (Corn Starch), by weight of said composition;
VI. emulsifier component at 1.1% (Lecithin), by weight of said composition;
VII. a 37.1% water component, by weight of said composition;
VIII. a natural preservative tocopherols at 0.001% of composition, by weight of said composition.

The composition may include just component I, or any of the following combinations: I and II; I, II, and III; I, II, III, and IV; I, MIL IV, and V; I, II, III, IV, V, and VI; I, II, III, IV, V, VI, and VII; and I, II, III, IV, V, VI, VII, and VIII. Additional embodiments include adding an additional component selected from the group consisting of a flavor component, a color component, a preservative component, a stabilizing component, an emulsifier component, a thickening component that includes hydrocolloids including; gelatin, gellan gum, xanthan gum, pectin, carrageenan, cellulose gum, gum arabic, modified starch and combinations thereof, a supplement component that can include organic food acids selected from the group consisting of citric acid, malic acid, lactic acid, fumaric acid, tartaric acid and adipic acid, a nutraceutical component, a vitamin, a mineral, a medicine component or combinations thereof.

An additional preferred embodiment includes a method of making a ground meat, processed meat, and/or game meat composition that includes adding a water component to a mixing and heating vessel, and then slowly adding an Inulin fiber component, corn starch as a thickening component, and vanilla powder on dextrose base a thickening and flavor component while mixing vigorously until homogeneous; then add the highly unsaturated liquid edible oil component (Canola Oil), add the highly saturated oil (coconut oil), and the emulsifier component lecithin and continue to mix until homogeneous; then increase the heat until the composition reaches about 150° F. while continuously mixing vigorously for about 5 minutes to about 30 minutes to completely emulsify the oil in water composition and create the final fat emulsion composition. The composition may slowly thicken during the heating and mixing stage of the process until the ingredients thicken into a homogeneous fat emulsion composition. The temperature then may be lowered while mixing in the tocopherols for a natural preservative and additional flavors, colors, or preservatives while mixing with agitation for another 5 minutes. The fat emulsion would then be added to the ground meat or processed meat or game meat at around 100° F. or higher in a mixing vessel, preferably with a beater bar attachment, or the fat emulsion can be hand blended into the ground meat or processed meat or game meat. The mixing or hand blending may last long enough to allow the fat emulsion to thoroughly spread out into the ground meat or processed meat or game meat.

Another preferred embodiment includes a ground sausage composition. Such a ground meat sausage comprises the following:
a. from about 30 to about 98% of sausage; and
b. from about 2 to about 70% of a fat emulsion that includes the following:
1. from about 1 to about 30% of a highly unsaturated liquid edible oil component;
2 from about 0.3 to about 10% of a coconut oil component (medium heat refined coconut oil);
3. from about 0.001 to about 70% of a fiber component (preferably Inulin);
4. from about 0 to about 5% of a vanilla powder component on dextrose base;
5. from about 0.001 to about 30% of a thickening component (Corn Starch);
6. from about 0.001 to about 30% of an emulsifier component (Lecithin);
7. from about 1 to about 60% of a water component; and
8. from about 0 to about 1% of a natural preservative tocopherols.

A particularly preferred embodiment includes a ground sausage composition that includes:

a. 80% processed sausage meat (beef, turkey, chicken, pork, etc.); and

b. 20% of a fat emulsion that includes one or more of the following components:
I. highly unsaturated liquid edible oil component at 6% (Canola Oil);
II. 0.8% coconut oil component (medium heat refined coconut oil);
III. fiber component at 38.3% (Inulin);
IV. vanilla powder component on dextrose base at 1.1%;
V. a thickening component at 17.7% (Corn Starch);
VI. emulsifier component at 1.1% (Lecithin);
VII. 35% water component; and
VIII. a natural preservative tocopherols at 0.001% of composition weight.

The composition may include just component I, or any of the following combinations: I and II; I, II, and III; I, II, III, and IV; I, II, III, IV, and V; I, II, III, IV, V, and VI; I, II, III, IV, V, VI, and VII; and I, II, III, IV, V, VI, VII, and VIII. Additional embodiments include adding an additional component selected from the group consisting of a flavor component, a color component, a preservative component, a stabilizing component, an emulsifier component, a thickening component that includes hydrocolloids including; gelatin, gellan gum, xanthan gum, pectin, carrageenan, cellulose gum, gum arabic, modified starch and combinations thereof, a supplement component that can include organic food acids selected from the group consisting of citric acid, malic acid, lactic acid, fumaric acid, tartaric acid and adipic acid, a nutraceutical component, a vitamin, a mineral, a medicine component or combinations thereof.

Another feature of a preferred embodiment provides a method of making a ground sausage that includes: adding a water component to a mixing and heating vessel, adding slowly an Inulin fiber component, corn starch as a thickening component, and vanilla powder on dextrose base as a thickening and flavor component while mixing vigorously until homogeneous; then adding a highly unsaturated liquid edible oil component (Canola Oil), a highly saturated oil (coconut oil), and an emulsifier component (lecithin) while continuing to mix until homogeneous. The method also includes increasing the heat of the homogeneous mixture until the composition reaches 150° F. while continuously mixing vigorously for about 5 minutes to about 30 minutes to completely emulsify the oil in water composition and create the final fat emulsion composition. The composition may slowly thicken during the heating and mixing stage of the process until the ingredients thicken into a homogeneous fat emulsion composition. The temperature may then be lowered while mixing in the tocopherols for a natural preservative and additional flavors, colors, or preservatives while mixing with agitation for another 5 minutes. The fat emulsion would then be added to the ground sausage at around 100° F. or higher in a mixing vessel, optionally with a beater bar attachment, or the fat emulsion can be hand blended into the ground meat or processed meat or game meat. The mixing or hand blending may last long enough to allow the fat emulsion to thoroughly spread out into the sausage meat or processed meat or game meat.

The components of the fat emulsion are described in more detail below.

### Ground Meat, Processed Meat or Game Meat

The composition may include a ground meat, processed meat, game meat, and/or sausage product that includes: beef, pork, chicken, turkey, or any other commercial or game meats at 30% or greater, alternatively 30% to 35%, alternatively 35% to 40%, alternatively 40% to 45%, alternatively 45% to 50%, alternatively 50% to 55%, alternatively 55% to 60%, alternatively 60% to 65%, alternatively 65% to 70%, alternatively 70% to 75%, alternatively 75% to 80%, alternatively 80% to 85%, alternatively 85% to 90%, alternatively 90% to 95%, and alternatively 95% to 99.999%, by weight of the composition.

This ground meat, processed meat, game meat, or sausage meat may have any fat content. The preferable fat content for the meat would be towards the leaner content because this allows the fat emulsion to take place of what would normally be fat within a meat or processed meat or game meat. Typical fat contents found in conventional meat products sold commercially in the United States is between about 2% and about 50% fat. A preferred fat content would be 5% or less to allow the fat emulsion to have the greatest impact on improving nutritional structure. It is to be understood that certain high fat meat products like sausage, pepperoni, or salami would have higher fat contents than meat like ground beef before the fat emulsion is added to the meat. These products may have a fat content of up to 50% or higher fat, and can benefit from the aspects of the embodiments disclosed herein.

### Fat Emulsion Composition

The composition of the ground meat, processed meat, game meat or sausage includes a fat emulsion at 70% or less, alternatively 70% to 65%, alternatively 65% to 60%, alternatively 60% to 55%, alternatively 55% to 50%, alternatively 50% to 45%, alternatively 45% to 40%, alternatively 40% to 35%, and alternatively 35% to 30%, alternatively 30% to 25%, alternatively 25%, to 20%, alternatively 20% to 15%, alternatively 15% to 10%, alternatively 10% to 5%, and alternatively 5% to 2%, by weight of the composition.

The fat emulsion has the same characteristics as fat used within ground meat, processed meat, game meat or sausage. One of the negative issues with meat products is the levels of total fat, saturated fat and cholesterol. The bulk of the meats sold in the global market have fat content of 20% or higher. This fat content has a high level of animal saturated fat proven to increase the risk of cardiovascular disease. To date there hasn't been any fat substitute that replaces the fat within meat products well without adding similar levels of fat to the final meat product. The embodiments described herein not only replace the fat within meat products, but the fat emulsion has significant health benefits because it adds to the meat products when utilized including: adding beneficial dietary fiber, adding antioxidants, lowering fat content and especially saturated fat content and cholesterol when compared to similar percentage meat products, adding beneficial essential fatty acids Omega 6's and Omega 3 ALA's, and other potential health benefits with use of additional nutritive ingredients within the fat emulsion. The fat emulsion can have as low as 3% total fat content within it and when it replaces fat within ground meat, processed meat or game meat is reduces the fat content by 97% when replacing the fat on a 1 to 1 basis.

### Liquid Edible Oil Component

The composition of the fat emulsion preferably has an edible oil component with a highly unsaturated fat component at 1% to 30%, preferably 2% to 20%, and most preferably 3% to 8%, by weight of the composition. This edible oil component makes up part of the group of ingredients that are believed to adjust the taste, texture, and improve the mouth feel of the ground meat, processed meat or game meat. The interaction of the group of highly unsaturated oils with the coconut oil component creates an improved elasticity within the fat composition that acts similar to hydrogenated or partially hydrogenated fat within our compositions. The edible oil component also is believed to improve the health characteristic of the fat compositions because it adds monounsaturated and polyunsaturated fats. An example of an edible oil component is a blend of canola, soybean oil, and sunflower oil or canola oil. Non-limiting examples of an edible oil component acceptable for use in the fat emulsion are those that have low saturated fat content and high unsaturated fat including monounsaturated and especially polyunsaturated oils. The edible oil component preferably has no specific flavor and should be basically bland or somewhat buttery in taste. The edible oils component can come from one or more of the following; canola oil, soybean oil, safflower oil, sunflower oil, sesame oil, walnut oil, olive oil, flaxseed oil, chia seed oil, almond oil, corn oil, grape seed oil, peanut oil, other nut oils, and synthesized or reorganized oils, and combinations thereof.

### Highly Saturated Oil Component

The fat emulsion preferably includes a highly saturated oil component at from about 0.3% to 10%, preferably 0.5% to 8%, more preferably 0.7% to 5%, and most preferably 0.8% to 3%, by weight of the composition. The preferred highly saturated oil component is coconut oil, and is believed to form a part of the antioxidant flavor profile and unique texture that that fat emulsion provides in meat products. The blend of the antioxidant flavor components is believed to provide a mechanism for accomplishing great taste, texture, and mouth feel without needing a high fat content within the fat emulsion. Any medium heat processed coconut oil can be used for the coconut oil component.

The highly saturated oil component may be selected from one or more of the group consisting of coconut oil, palm oil, fractionated coconut or palm oil, partially hydrogenated coconut or palm oil, fully hydrogenated coconut or palm oil, or any other synthesized or altered edible oils including partially hydrogenated oils and fully hydrogenated oils that have either highly saturated or highly unsaturated fatty acids that when hydrogenated become solid similar to coconut oil in consistency including partially hydrogenated soybean oil, cotton seed oil, palm kernel oil or combination of these edible oils.

### Fiber Component

The fat emulsion preferably includes include a fiber component at 0.001% to 70%, preferably 2% to 60%, more preferably 10% to 55%, and most preferably 20% to 50%, by weight of the composition. The preferred fiber component is Inulin or wheat dextrin. Inulin or wheat dextrin acts as a thickening agent and also improves the texture of the fat emulsion component and adds beneficial dietary fiber to the meat products. Various load rates of dietary fiber can be incorporated in the fat emulsion to create improved texture and mouth feel and at certain load rates can provide dietary fiber benefits including promoting a healthy digestion system, controlling blood sugar levels, and providing probiotic benefits. The addition of the dietary fiber along with the remainder of the fat emulsion components permits the addition of water into the fat emulsion that helps displace total fat, saturated fat and cholesterol.

Agglomerated psyllium, oat bran or other allowable fiber sources can form all or a portion of the fiber component used in the fat emulsion. This soluble fiber can be added into the fat emulsion as part of the meat products at levels that allow the FDA soluble fiber “Heart Healthy” claim to be made. Within certain embodiments, the total fat content of the ground meat, processed meat, game meat or sausage can be 3 grams of total fat or less, 1 gram of saturated fat or less and 25 mg of cholesterol or less per serving, as well as having the amount of soluble fiber as part of the fat emulsion that allows for this FDA soluble fiber “Heart Healthy” claim to be made. No other ground meat, processed meat, game meat, or sausage can make this claim because the soluble fiber components necessary to make this FDA heart health claim are difficult to impossible to incorporate into meat products, without following the guidelines provided herein. Using the guidelines provided, persons having ordinary skill in the art will be capable of incorporating a desirable degree of fiber into the fat emulsion that is then added to the meat product to produce a desirable meat product composition low in fat and high in fiber.

The fiber component also may be selected from one or more of the group consisting of naturally derived soluble fiber, naturally derived inulin, inulin extract, synthetic inulin, hydrolysis products of inulin commonly known as fructooligosaccharides, galacto-oligosaccharides, xylooligosaccharides, oligo derivatives of starch; husks; brans; psyllium; polysaccharides, starches; polycarbophil; lignin; arabinogalactans; chitosans; oat fiber; soluble corn fiber, non-digestible corn dextrin; non-digestible wheat dextrin; locust bean gum and derivatives of locust bean gum; hydroxypropylmethyl cellulose (HPMC);pectin; and mixtures thereof.

### Vanilla Powder Component

The fat emulsion composition may include a vanilla powder component at 0% to 5%, preferably 1% to 4%, and most preferably 1.5% to 3%, by weight of the composition. This vanilla powder component preferably is derived from a vanilla extract sprayed on a dextrose base. The blend of flavor components adds to the great taste, texture, and mouth feel within the fat emulsion composition part of the meat products. Therefore, it is preferred that the vanilla powder component have a specific flavor profile, and Cook's Flavoring Company currently sells a vanilla powder that has the preferred flavor profile of the present embodiments. Another vanilla powder or natural vanilla extract could be used, but it should have a similar taste profile as the Cook's Flavoring Company's vanilla powder.

### Thickening Component

The fat emulsion composition preferably includes a thickening component at 0.001% to 30%, preferably 1% to 18%, more preferably 2% to 16%, and most preferably 3% to 15%, by weight of the composition. The thickening component can be selected from the group including polysaccharides, vegetable gums, and pectin or any combination of these thickening agents. The thickening component helps provide the structure for thel fat emulsion composition that can replace the fat content within ground meat, processed meat or game meat on a 1 to 1 basis and helps create the rheological characteristics similar to meat fat of the final fat emulsion composition. Corn starch is the preferred thickening agent for the present invention.

### Emulsifier Component

The fat emulsion composition may include an emulsifier component at 0% to 10%, or from 0.001% to 5%, preferably 0.5% to 3%, and most preferably 1% to 2%, by weight of the composition. This emulsifier component can come from several different sources known in the food industry. A preferred emulsifier that may be used is lecithin, which can be used alone or in combination with other known emulsifiers. The emulsifier agent acts as the binding agent keeping the mixture of the oil in water fat emulsion together and helps make the final fat emulsion composition structure act like meat fat.

### Water Component

The fat emulsion composition may include a water component at 1% to 60%, preferably 3% to 50%, more preferably 7% to 45%, and most preferably 15% to 40%, by weight of the composition. This water component may be derived from any suitable drinkable or otherwise potable water source. All or a portion of the water component may be derived from an ingredient that has water as its primary component such as milk, buttermilk, or other source of liquid that contain water as the primary ingredient. The water component makes up a significant portion of the fat emulsion and allows it to have the rheological characteristics of meat fat with similar melt and chewiness as meat fat. Water is a component because creating an oil in water fat emulsion and adding the additional components to the fat emulsion composition with a solid continuous phase can have varied viscosities based on the amount of water within the composition. This provides for the ability to match different types of meat fat viscosity by adjusting the amount of water within the fat emulsion component.

Additionally, embodiments of the fat emulsion compositions can include at least about 0% or greater, by weight of the composition, of an additive selected from a flavor component, a color component, a preservative component, a stabilizing component, an emulsifier component, a thickening component, a gelling component like gelatin or pectin, a supplement component that can include a protein source like whey protein isolate or another protein source suitable for processing in a flavored chewy candy or gummy confection, a nutraceutical component, a medicine component or combinations thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The ground meat, processed meat, game meat, or sausage composition can be made by adding the water component to a mixing and heating vessel, adding slowly the Inulin fiber component, corn starch as a thickening component, and the vanilla powder on dextrose base as a thickening and flavor component while mixing vigorously; then adding a highly unsaturated liquid edible oil component (Soybean Oil, Canola Oil, and Sunflower Oil or Canola Oil), the highly saturated oil (coconut oil), and the emulsifier component (preferably lecithin) and continue to mix. The method further includes increasing the heat of the homogeneous mixture until the mixture reaches about 150° F. while continuously mixing vigorously for about 5 minutes to about 30 minutes to completely emulsify the oil in water fat emulsion composition and create the final thickened fat emulsion composition. The composition may slowly thicken during the heating and mixing stage of the process until the ingredients thicken into a thick fat emulsion composition. The temperature then can be lowered while mixing in the tocopherols as a natural preservative in a water based emulsion and additional flavors, colors, or preservatives while blending with agitation for another 5 minutes.

Additionally, embodiments of the fat emulsion compositions can include at least about 0% or greater, by weight of the composition, of one or more additives selected from a flavor component, a color component, a preservative component non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof, a stabilizing component, an emulsifier component, a thickening component, a gelling component like gelatin or pectin, a supplement component that can include a protein source like whey protein isolate or another protein source suitable for processing in a fat emulsion composition, a nutraceutical component, a medicine component or combinations thereof.

Non-limiting examples of additional components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger; grapes, catechins and polyphenols from teas, onions, phytosterols, isoflavones, lycopene, curcumin, caffeine; glucosamine, chondroitin, msm; melatonin, seratonin; and mixtures thereof.

The final fat emulsion composition then can be added to the ground meat, processed meat, game meat, or sausage at a temperature of about 100° F. in a heated mixing vessel. A beater bar attachment can be used in the mixer or the fat emulsion can be hand blended into the ground meat or processed meat or game meat. The mixing or hand blending could last long enough to allow the fat emulsion to thoroughly spread out into the meat product. A large commercial production line could be set up that uses a larger mixer and then a Vmag type of extruder with a ground meat attachment or other meat processing attachment depending on the type of ground meat, processed meat, game meat or sausage being produced.

The invention will now be described with reference to the following non-limiting examples.

### EXAMPLES

The below examples are included for illustrative purposes only and are not intended to in any way limit the scope of the present invention. The symbol # denotes pounds in the examples.

### Example 1

### A 97.5% Lean Ground Beef and an Excellent Source of Dietary Fiber Per 100 g Serving

The following ingredients were added into a mixing and heating vessel; 37.1 # of drinkable water, then slowly add while mixing 41# of Inulin (dietary fiber component), 15.6# of corn starch a thickening component, 1.1# vanilla powder on dextrose base (a flavor and thickening component). These ingredients were mixed until they became homogeneous. To this homogeneous mixture then were added 3.3# of a liquid edible vegetable oil blend (Soybean Oil, Canola Oil, and Sunflower Oil), sold by Crisco, 0.8# medium refined coconut oil, 1.1# lecithin (an emulsifier). These ingredients were mixed together until they became a viscous composition. The complete group of ingredients were then be brought up to 150° F. while being mixed vigorously for about 5 to about 30 minutes in order to completely emulsify the ingredients. During the heating stage the mixture began to thicken into a more viscous, more solid looking fat emulsion composition. Once this thickened more viscous stage had been achieved, the fat emulsion composition was then slowly cooled and tocopherols (a natural preservative) were added to the fat emulsion composition and mixed for about 10 minutes to completely blend in the preservative component. The fat emulsion composition then was added into 625# of 96/4 extra lean ground sirloin at 100° F. in a heating and mixing vessel. The ground sirloin and fat emulsion composition was blended together until the fat emulsion became completely dispersed through the ground sirloin, which took about 10 to 15 minutes or longer. The final meat product including now the fat emulsion was transferred into a large meat grinder and then packaged in individual packs or made into burgers.

### Example 2

### A Pork Breakfast Sausage with Significantly Less Total Fat, Saturated Fat and Cholesterol and an Excellent Source of Dietary Fiber Per 56 g Serving

The following ingredients were added into a mixing and heating vessel; 35 # of drinkable water, then slowly add while mixing 38.3# of Inulin (dietary fiber component); 17.7# of corn starch as a thickening component, 1.1# vanilla powder on dextrose base (a flavor and thickening component). These ingredients were mixed until they became homogeneous. To the homogeneous composition then were added about 6# of a liquid edible vegetable oil blend (Soybean Oil, Canola Oil, and Sunflower Oil), sold by Crisco, 0.8# medium refined coconut oil, 1.1 # lecithin (an emulsifier), and all ingredients were mixed together until they became a viscous composition. The complete group of ingredients were then be brought up to 150° F. while being mixed vigorously for 5 to 30 minutes in order to completely emulsify the ingredients. During the heating stage the mixture began to thicken into a more viscous more solid looking fat emulsion composition. Once this thickened, more viscous stage had been achieved, the fat emulsion composition was then slowly cooled, and tocopherols (a natural preservative) were added to the fat emulsion composition and mixed for 10 minutes to completely blend in the preservative component.

The fat emulsion composition then was added into 500# of pork breakfast sausage at 100° F. in a heating and mixing vessel. The pork sausage and fat emulsion composition was blended together until the fat emulsion became completely dispersed through the breakfast sausage, which took about 10 to 15 minutes of blending or longer. The final breakfast sausage product including now the fat emulsion within the sausage was transferred into a large extruder and made into either sausage sleeves or sausage patties or links and packaged into retail packaging.

### Example 3

### A Processed Turkey Breast with Extra Lean Fat Content and Excellent Source of Dietary Fiber Per 55 g Serving

The following ingredients were added into a mixing and heating vessel; 37 # of drinkable water, then slowly add while mixing 30# of Inulin (dietary fiber component), 20# of corn starch (a thickening component), 1.1# vanilla powder on dextrose base (a flavor and thickening component), and the ingredients mixed until they became homogeneous. To the homogeneous mixture then were added about 10# of a liquid edible vegetable oil blend (Soybean Oil, Canola Oil, and Sunflower Oil), sold by Crisco, 0.8# medium refined coconut oil, 1.1# lecithin (an emulsifier), and all ingredients were mixed until they became a viscous composition. The complete group of ingredients were then brought up to 150° F. while being mixed vigorously for 5 to 30 minutes in order to completely emulsify the ingredients. During the heating stage the mixture began to thicken into a more viscous, more solid looking fat emulsion composition. Once this thickened, more viscous stage had been achieved, the fat emulsion composition was then slowly cooled and tocopherols (a natural preservative) were added to the fat emulsion composition and mixed for 10 minutes to completely blend in the preservative component.

The fat emulsion composition was then added into 333# of processed turkey breast at 100° Ft in a heating and mixing vessel. The processed turkey breast and fat emulsion composition was blended together until the fat emulsion became completely dispersed through the processed turkey breast, which took about 10 to 15 minutes of blending or longer. The final processed turkey breast product including now the fat emulsion within the processed turkey breast was transferred into a large processed meat manufacturing machine and turned into a pressed turkey breast as whole turkey breast or was processed into sliced turkey for retail in individual packages.

### Example 4

### A Ground Caribou that is 97.5% Lean and an Excellent Source of Dietary Fiber Per 100 g Serving

The following ingredients were added into a mixing and heating vessel; 3.7 # of drinkable water, then slowly add while mixing 3.5# of Inulin (dietary fiber component) 2.2# of corn starch a thickening component, 0.1# vanilla powder on dextrose base (a flavor and thickening component) and the ingredients mixed until they became homogeneous. To the homogeneous mixture then were added about 0.33# of a liquid edible vegetable oil blend (Soybean Oil, Canola Oil, and Sunflower Oil), sold by Crisco, 0.08# medium refined coconut oil, 0.01# lecithin (an emulsifier), and all ingredients were mixed together until they became a viscous composition. The complete group of ingredients were then brought up to 150° F. while being mixed vigorously for 5 to 30 minutes in order to completely emulsify the ingredients. During the heating stage the mixture began to thicken into a more viscous, more solid looking fat emulsion composition. Once this thickened, more viscous stage had been achieved, the fat emulsion composition was slowly cooled and tocopherols (a natural preservative) were added to the fat emulsion composition and mixed for 10 minutes to completely blend in the preservative component.

The fat emulsion composition then was added into about 10# of Caribou meat at 100° F. in a heating and mixing vessel. The ground Caribou and fat emulsion composition was blended together until the fat emulsion became completely dispersed through the ground Caribou, which took about 10 to 15 minutes or longer. The final game meat product including now the fat emulsion within the ground Caribou was transferred into a meat grinder and then packaged in individual packs or made into burgers.

The above four examples provide examples of ground meat, processed meat, game meat or sausage compositions that can produce a great tasting improved health characteristics group of meat products. This embodiments can create a wide range of different ground meat, processed meat, game meat and/or sausage compositions based on varying the amounts certain ingredients within to provide positive health benefits to current meat products.

All documents cited in this disclosure are incorporated herein by reference in their entireties, and the citation of any document is not to be construed as an admission that it is prior art with respect to the present embodiments. To the extent that any meaning or definition of a term in this document conflicts with any meaning or definition of the term in a document incorporated by reference, the meaning or definition assigned to the term in this document shall govern.

While particular embodiments of the present embodiments have been illustrated and described, it will be readily apparent to those skilled in the art that various other changes and modifications can be made without departing from the spirit and scope of the invention. It is therefore intended to cover in the appended claims all such changes and modifications that are within the scope of this invention.

What is claimed is:

1. A meat product composition comprising:
a. from about 30% to about 98% of meat having a total fat content of from about 2% to about 50% by weight; and
b. from about 2% to about 70% of a fat emulsion comprising (1) from about 1 to about 30% of a highly unsaturated liquid edible oil, (2) from about 0.3 to about 10% of a highly saturated oil, (3) from about 0.001 to about 70% of a fiber component, (4) from about 0.001 to about 30% of a thickening component, and (5) the balance water.

2. The composition of claim 1, wherein the meat is selected from ground meat, processed meat, and game meat.

3. The composition of claim 1, wherein the meat has a total fat content of 5% or less.

4. The composition of claim 1, wherein the highly unsaturated liquid edible oil is selected from the group consisting of canola oil, soybean oil, safflower oil, sunflower oil, sesame oil, walnut oil, olive oil, flaxseed oil, chia seed oil, almond oil, corn oil, grape seed oil, peanut oil, other nut oils, synthesized or reorganized oils, and mixtures and combinations thereof.

5. The composition of claim 4, wherein the highly unsaturated liquid edible oil is blend of canola oil, soybean oil, and sunflower oil.

6. The composition of claim 1, wherein the highly saturated oil is selected from the group consisting of coconut oil, palm oil, fractionated coconut or palm oil, partially hydrogenated coconut or palm oil, fully hydrogenated coconut or palm oil, partially hydrogenated soybean oil, cotton seed oil, palm kernel oil, and mixtures or combination thereof.

7. The composition of claim 6, wherein the highly saturated oil is coconut oil.

8. The composition of claim 1, wherein the fiber component is selected from the group consisting of naturally derived soluble fiber, naturally derived inulin, inulin extract, synthetic inulin, fructooligosaccharides, galacto-oligosaccharides, xylooligosaccharides, oligo derivatives of starch, husks, brans, psyllium, polysaccharides, starches, polycarbophil, lignin, arabinogalactans, chitosans, oat fiber, soluble corn fiber, non-digestible corn dextrin, non-digestible wheat dextrin, locust bean gum, derivatives of locust bean gum, hydroxypropylmethyl cellulose (HPMC), pectin, and mixtures thereof.

9. The composition of claim 8, wherein the fiber component is Inulin.

10. The composition of claim 1, wherein the thickening component is Corn starch.

11. The composition of claim 1, further comprising from about 0.001% to about 5% by weight of lecithin.

12. The composition of claim 11, further comprising from about 0 to about 5% of a vanilla powder component on dextrose base.

13. The composition of claim 12, further comprising an additive selected from the group consisting of a flavor component, a color component, a preservative component, a stabilizing component, an emulsifier component, a thickening component, gelatin, gellan gum, xanthan gum, pectin, carrageenan, cellulose gum, gum arabic, modified starch, a supplement component, citric acid, malic acid, lactic acid, fumaric acid, tartaric acid, adipic acid, a nutraceutical component, a vitamin, a mineral, a medicine component, calcium, potassium, B vitamins, vitamins A, C, D, E, and K, folic acid, ferulic acid, ginseng, ginko biloba, beta carotene, capsicanoids, anthocyanidins, bioflavinoids, d-limonene, isothiocyanates, cysteines from garlic, ginger, grapes, catechins, polyphenols, onions, phytosterols, isoflavones, lycopene, curcumin, caffeine, glucosamine, chondroitin, msm, melatonin, serotonin, and mixtures and combinations thereof.

14. A method of making a meat composition comprising:
adding water to a mixing and heating vessel;
slowly adding a fiber component and a thickening component to the water while mixing to provide a homogeneous mixture;
adding a highly unsaturated liquid edible oil and a highly saturated oil while mixing to provide a homogeneous mixture;
heating the homogeneous mixture to a temperature within the range of from about 130 to about 175° F. while mixing for about 1 minute to about 90 minutes to emulsify the oil in water composition and create a fat emulsion;
reducing the temperature of the fat emulsion while mixing; and
adding meat at a temperature of from about 85 to about 125° F. to blend the emulsion into the meat and prepare a meat composition.

15. The method of claim 14, wherein the fat emulsion comprises from about 2% to about 70% of the meat composition, and the meat comprises from about 30% to about 98% of the meat composition.

16. A ground sausage composition comprising:
a. from about 30% to about 98% of ground sausage selected from beef, turkey, chicken, pork, and mixtures thereof; and
b. from about 2% to about 70% of a fat emulsion comprising (1) from about 1 to about 30% of a highly unsaturated liquid edible oil, (2) from about 0.3 to about 10% of a highly saturated oil (e.g., coconut oil), (3) from about 0.001 to about 70% of a fiber component, (4) from about 0.001 to about 30% of a thickening component, and (5) the balance water.

17. The composition as claimed in claim 16, further comprising from about 0 to about 5% of a vanilla powder component on dextrose base.

18. The composition of claim 16, further comprising an additive selected from the group consisting of a flavor component, a color component, a preservative component, a stabilizing component, an emulsifier component, a thickening component, gelatin, gellan gum, xanthan gum, pectin, carrageenan, cellulose gum, gum arabic, modified starch, a supplement component, citric acid, malic acid, lactic acid, fumaric acid, tartaric acid, adipic acid, a nutraceutical component, a vitamin, a mineral, a medicine component, calcium, potassium, B vitamins, vitamins A, C, D, E, and K, folic acid, ferulic acid, ginseng, ginko biloba, beta carotene, capsicanoids, anthocyanidins, bioflavinoids, d-limonene, isothiocyanates, cysteines from garlic, ginger, grapes, catechins, polyphenols, onions, phytosterols, isoflavones, lycopene, curcumin, caffeine, glucosamine, chondroitin, msm, melatonin, serotonin, and mixtures and combinations thereof.

19. A method of making a sausage composition comprising:
adding water to a mixing and heating vessel;
slowly adding a fiber component and a thickening component to the water while mixing to provide a homogeneous mixture;
adding a highly unsaturated liquid edible oil and a highly saturated oil while mixing to provide a homogeneous mixture;
heating the homogeneous mixture to a temperature within the range of from about 130 to about 175° F. while mixing for about 1 minute to about 90 minutes to emulsify the oil in water composition and create a fat emulsion;
reducing the temperature of the fat emulsion while mixing; and
adding sausage at a temperature of from about 85 to about 125° F. to blend the emulsion into the sausage and prepare a sausage composition

20. The method of claim 19, wherein the fat emulsion comprises from about 2% to about 70% of the sausage composition, and the sausage comprises from about 30% to about 98% of the sausage composition.
